(19) United States
(12) Patent Application Publication
(10) Pub. No.: US 2024/0006987 A1
(43) Pub. Date: Jan. 4, 2024

(54) BRIDGELESS DIGITAL CONTROL POWER FACTOR CORRECTION CIRCUIT

(71) Applicant: Pacific Import Manufacturing, Inc., City of Industry, CA (US)

(72) Inventors: Zhen-Qiu Huang, Alhambra, CA (US); Xining Wang, City of Industry, CA (US)

(21) Appl. No.: 18/217,308

(22) Filed: Jun. 30, 2023

Related U.S. Application Data
(60) Provisional application No. 63/357,937, filed on Jul. 1, 2022.

(51) Int. Cl. H02M 1/42; H02M 1/00

(52) U.S. Cl. CPC H02M 1/4225; H02M 1/0085

(57) ABSTRACT

Embodiments of the present invention relate to a bridgeless digital control power factor correction (PFC) circuit, with a symmetrical and balanced topology, for use in a device to eliminate the use of standby power when a plug is sitting idle in a socket. In embodiments, the bridgeless power factor correction circuit includes: a boost inductor, where the bridgeless power factor correction circuit has a symmetrical topology, and the boost inductor comprises an axis of the bridgeless power factor correction circuit; a first metal-oxide-semiconductor field-effect transistor (MOSFET) and a second MOSFET; and four diodes, wherein the four diodes comprise two slow diodes and two fast diodes. Embodiments of the present invention also relate to a power factor correction circuit, and methods of manufacturing the bridgeless power factor correction circuit and the power factor correction circuit.

### CROSS-REFERENCE TO RELATED APPLICATIONS

The present application claims the benefit of and priority to U.S. Provisional Application No. 63/357,937, filed on Jul. 1, 2022, entitled “BRIDGELESS DIGITAL CONTROL POWER FACTOR CORRECTION CIRCUIT”, which application is incorporated herein by reference in its entirety.

### FIELD OF THE INVENTION

Embodiments of the present invention relate to a bridgeless digital control power factor correction system in power conversion, and more specifically to an upstream field of AC-DC power conversion and is intended for AC-DC power factor correction (“PFC”). Embodiments of the present invention may be used to provide a device that eliminates the use of standby power when a plug is sitting idle in a socket.

### BACKGROUND OF THE INVENTION

Power factor is an indicator of electric power quality and is defined as the ratio of real power to apparent power. Real power is also known as active power and working power. Reactive power is power that is not used and returned to the power system. In other words, power factor measures how efficiently incoming power is used in a device. When power factor=active power/apparent power=1, no reactive power is produced, and electric power quality is the best. However, when there is a phase difference between the voltage and current, negative power (e.g., reactive power) is generated, resulting in a poor power factor. Poor power factor is inefficient, puts unnecessary strain on a power system, and may cause issues with other connected devices.

Two main causes of poor power factor are: displacement and distortion. Displacement occurs when a circuit's voltage and current waves are out of phase. Displacement may be corrected with external reactive components. Distortion occurs when there is an alteration of the current wave's shape. Distortion may be corrected using passive filters to filter out harmonics (e.g., low power applications) or using a switching converter to modulate the distorted wave. Displacement and distortion created when converting from AC to DC may flow back to the power source (e.g., power grid).

Power factor correction (PFC) tries to improve a device's power factor by reducing displacement/distortion. Power factor correction uses various techniques to make the waveform of the input current as close to a sinusoidal waveform and to adjust the phase of the current to be the same as the voltage (e.g., no phase difference). Previous attempts have been made to manufacture power factor correction circuits that improve power factor.

### SUMMARY OF THE INVENTION

These and other needs are addressed by the various embodiments and configurations of the present invention. This invention relates to a novel system, device, and methods for providing a bridgeless digital power factor correction (PFC) circuit that may be used in a device to eliminate the use of standby power when a plug is sitting idle in a socket. For example, when a device is fully charged, but still plugged in. In another example, when a device is plugged in but turned off/in sleep mode or otherwise not consuming power. It is to be understood that, while an example of a plug sitting idle in a socket is given, aspects of the present disclosure are in no way limited to such examples, and alternative scenarios are contemplated.

Due to the numerous limitations associated with the prior art described above, the following disclosure describes an improved power factor correction circuit that is bridgeless, with a symmetrical and a balanced topology. This novel feature provides a device that eliminates the use of standby power when a plug is sitting idle in a socket, significantly improving the power factor of an idle device.

Embodiments of the present invention generally relate to an upstream field of AC-DC power conversion and is intended for AC-DC power factor correction (“PFC”). The bridgeless digital power factor correction circuit acquires maximum active power within an AC circuit and raises system conversion efficiency (e.g., reduces generation of reactive power).

In one embodiment, a bridgeless power factor correction circuit comprises: a boost inductor, wherein the bridgeless power factor correction circuit has a symmetrical topology, and wherein the boost inductor comprises an axis of the bridgeless power factor correction circuit; a first metal-oxide-semiconductor field-effect transistor (MOSFET) and a second MOSFET; and four diodes, wherein the four diodes comprise two slow diodes and two fast diodes.

In one embodiment, a device comprises: a bridgeless power factor correction circuit comprising: a boost inductor; a first metal-oxide-semiconductor field-effect transistor (MOSFET) and a second MOSFET; and four diodes, wherein the four diodes comprise two slow diodes and two fast diodes; and a plug.

In one embodiment, a bridgeless power factor correction circuit comprises: a boost inductor; a first metal-oxide-semiconductor field-effect transistor (MOSFET) and a second MOSFET; and four diodes.

Further example aspects of the present disclosure include, a bridgeless power factor correction circuit as described herein.

Further example aspects of the present disclosure include, a method of manufacturing a bridgeless power factor correction circuit.

Further example aspects of the present disclosure include, a power factor correction circuit.

Further example aspects of the present disclosure include, a method of manufacturing a power factor correction circuit.

Any of the aspects herein, further comprising: a common mode choke, wherein the common mode choke is installed at an input terminal of the bridgeless power factor correction circuit.

Any of the aspects herein, further comprising: a digital microcontroller unit (MCU).

Any of the aspects herein, wherein the first MOSFET turns ON the second MOSFET, and wherein when the second MOSFET is ON the boost inductor enters an energy storage mode.

Any of the aspects herein, wherein the second MOSFET is OFF, and wherein when the second MOSFET is OFF the boost inductor enters a boost output mode.

Any of the aspects herein, wherein the second MOSFET turns ON the first MOSFET, and wherein when the first MOSFET is ON the boost inductor enters an energy storage mode.

Any of the aspects herein, wherein the first MOSFET is OFF, and wherein when the first MOSFET is OFF the boost inductor enters a boost output mode.

Any of the aspects herein, wherein the bridgeless power factor correction circuit has a symmetrical topology.

Any of the aspects herein, wherein the boost inductor comprises an axis of the bridgeless power factor correction circuit.

Any of the aspects herein, wherein the bridgeless power factor correction circuit has a symmetrical topology, and wherein the boost inductor comprises an axis of the bridgeless power factor correction circuit

Any of the aspects herein, wherein the four diodes comprise two slow diodes and two fast diodes.

Further example aspects of the present disclosure include a bridgeless power factor correction circuit, comprising: a first switch circuit that includes a first metal-oxide-semiconductor field-effect transistor (MOSFET) and a first semiconductor; a second switch circuit that includes a second MOSFET and a second semiconductor; and an inductor connected to the first switch circuit and to the second switch circuit, wherein the first switch circuit and the second switch circuit are connectable to an alternating current power source to generate a direct current.

Any of the aspects herein, further comprising: a capacitor.

Any of the aspects herein, wherein the capacitor is wired in parallel with a load that receives the direct current.

Any of the aspects herein, wherein the first switch circuit further comprises a third semiconductor, and wherein the second switch circuit further comprises a fourth semiconductor.

Any of the aspects herein, wherein a first end of the inductor is connectable to the first switch circuit, and wherein a second end of the inductor opposite the first end is connectable to the second switch circuit.

Any of the aspects herein, wherein the third semiconductor is connected to the fourth semiconductor.

Any of the aspects herein, wherein the third semiconductor and the fourth semiconductor are placed in parallel with the inductor.

Any of the aspects herein, wherein a microcontroller unit turns on the second MOSFET, and wherein, when the second MOSFET is on, the inductor stores electrical energy.

Any of the aspects herein, wherein the second MOSFET is off, and wherein, when the second MOSFET is off, the inductor outputs electrical energy.

Any of the aspects herein, wherein a microcontroller unit turns on the first MOSFET, and wherein, when the first MOSFET is on, the inductor stores electrical energy.

Any of the aspects herein, wherein the first MOSFET is off, and wherein, when the first MOSFET is off, the inductor outputs electrical energy.

Further example aspects of the present disclosure include a device, comprising: a bridgeless power factor correction circuit, comprising: a first switch circuit that includes a first metal-oxide-semiconductor field-effect transistor (MOSFET) and a first semiconductor; a second switch circuit that includes a second MOSFET and a second semiconductor; and an inductor connected to the first switch circuit and to the second switch circuit, wherein the first switch circuit and the second switch circuit are connectable to an alternating current power source to generate a direct current; and a plug.

Any of the aspects herein, further comprising: a capacitor wired in parallel with a load that receives the direct current.

Any of the aspects herein, wherein the first switch circuit further comprises a third semiconductor, and wherein the second switch circuit further comprises a fourth semiconductor.

Any of the aspects herein, wherein a first end of the inductor is connectable to the first switch circuit, and wherein a second end of the inductor opposite the first end is connectable to the second switch circuit.

Any of the aspects herein, wherein the third semiconductor is connected to the fourth semiconductor.

Any of the aspects herein, wherein the third semiconductor and the fourth semiconductor are placed in parallel with the inductor.

Any of the aspects herein, wherein a microcontroller unit turns on the second MOSFET, and wherein, when the second MOSFET is on, the inductor stores electrical energy.

Any of the aspects herein, wherein the second MOSFET is off, and wherein, when the second MOSFET is off, the inductor outputs electrical energy.

Further example aspects of the present disclosure include a bridgeless power factor correction circuit, comprising: a first switch circuit that includes a first metal-oxide-semiconductor field-effect transistor (MOSFET), a first semiconductor, and a second semiconductor; a second switch circuit that includes a second MOSFET a third semiconductor, and a fourth semiconductor; and an inductor connected to at a first end to the first switch circuit and at a second end to the second switch circuit, wherein the first switch circuit and the second switch circuit are connectable to an alternating current power source to generate a direct current.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

Unless otherwise indicated, all numbers expressing quantities, dimensions, conditions, and so forth used in the specification and claims are to be understood as being modified in all instances by the term “about”.

The term “a” or “an” entity, as used herein, refers to one or more of that entity. As such, the terms “a” (or “an”), “one or more,” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

These and other advantages will be apparent from the disclosure of the invention(s) contained herein. The above-described embodiments, objectives, and configurations are neither complete nor exhaustive. The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

Any one or more aspects described herein can be combined with any other one or more aspects described herein. Any one or more features described herein can be combined with any other one or more features described herein. Any one or more embodiments described herein can be combined with any other one or more embodiments described herein.

### BRIEF DESCRIPTION OF THE DRAWINGS

Those of skill in the art will recognize that the following description is merely illustrative of the principles of the invention, which may be applied in various ways to provide many different alternative embodiments. This description is made for illustrating the general principles of the teachings of this invention and is not meant to limit the inventive concepts disclosed herein.

The accompanying drawings, which are incorporated in and constitute a part of the specification, illustrate embodiments of the invention and together with the general description of the invention given above and the detailed description of the drawings given below, serve to explain the principles of the invention.

FIG. 1 illustrates a power factor correction circuit in accordance with the present disclosure;

FIG. 2 illustrates a digital microcontroller unit (MCU) in accordance with the present disclosure;

FIG. 3 illustrates a system forward cycle in accordance with the present disclosure;

FIG. 4 illustrates a system forward cycle in accordance with the present disclosure;

FIG. 5 illustrates a system reverse cycle in accordance with the present disclosure;

FIG. 6 illustrates a system reverse cycle in accordance with the present disclosure;

FIG. 7 illustrates a bridgeless digital power factor correction system in accordance with the present disclosure; and

FIG. 8 illustrates a bridgeless digital power factor correction system in accordance with the present disclosure.

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

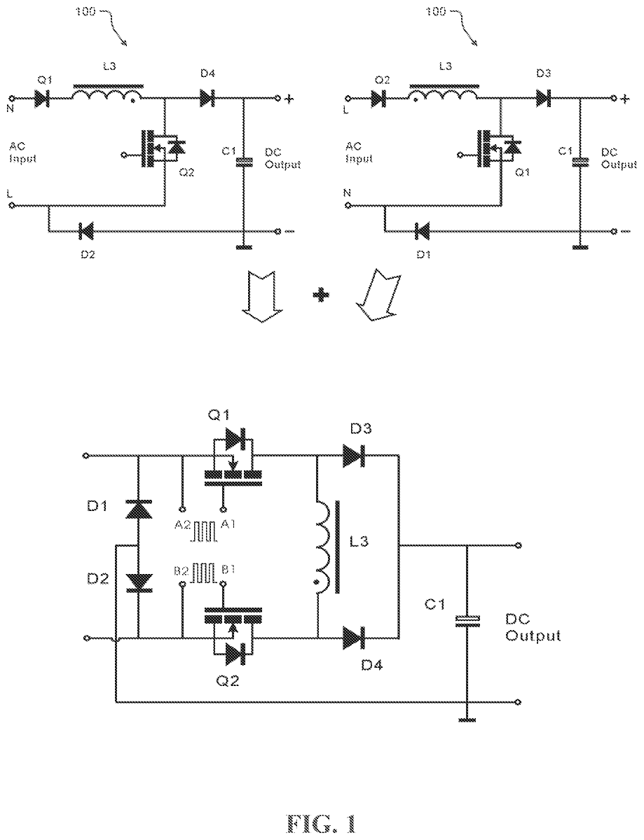

FIG. 1 illustrates a bridgeless power factor correction (PFC) circuit with a balanced topology. This topology conceals a pair of conventional boost PFC circuits (100), as shown in FIG. 1.

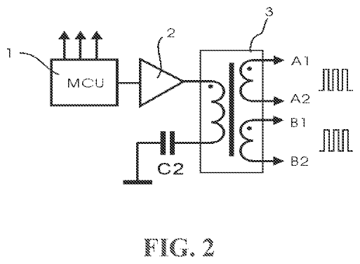

FIG. 2 is a schematic of the digital bridgeless PFC. The original drive system of the digital control drive system is composed of a digital microcontroller unit (MCU) 1, also known as a single chip microcomputer; a fast MOSFET gate driver 2; and a pulse transformer 3.

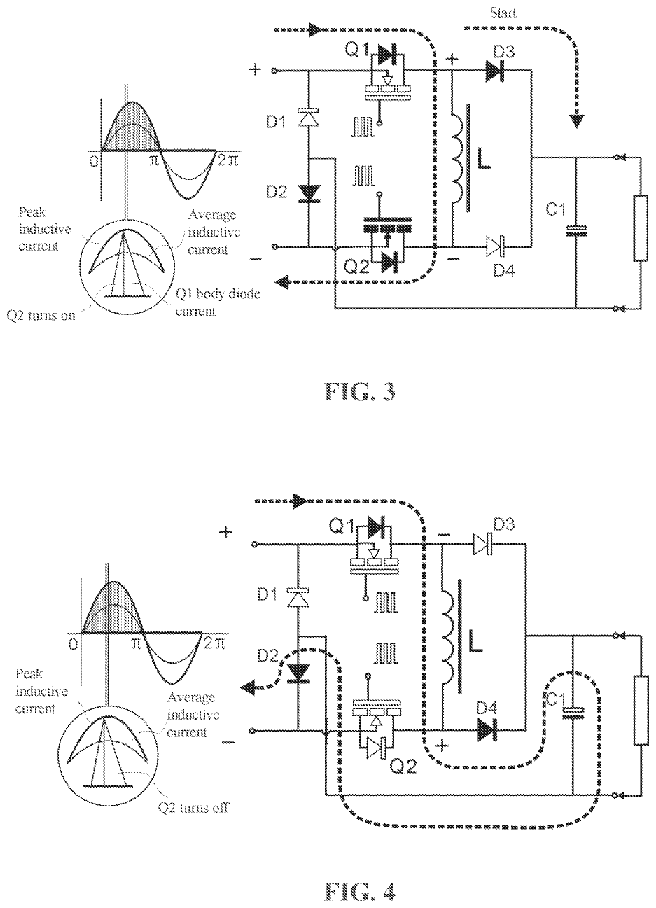

FIG. 3 illustrates the system forward cycle. Here, the Q1 and Q2 are both ON, causing the PFC circuit to operate and store the energy in the inductor L.

FIG. 4 illustrates the system forward cycle. Here, Q1 and Q2 are both OFF; and the inductor L enters boost output mode. The output bulk capacitor C1 stores the energy and the voltage is increased to above the peak of input voltage line

FIG. 5 illustrates the system reverse cycle. Here, the Q1 and Q2 are both ON, causing the PFC circuit to operate; and store the energy in the inductor L.

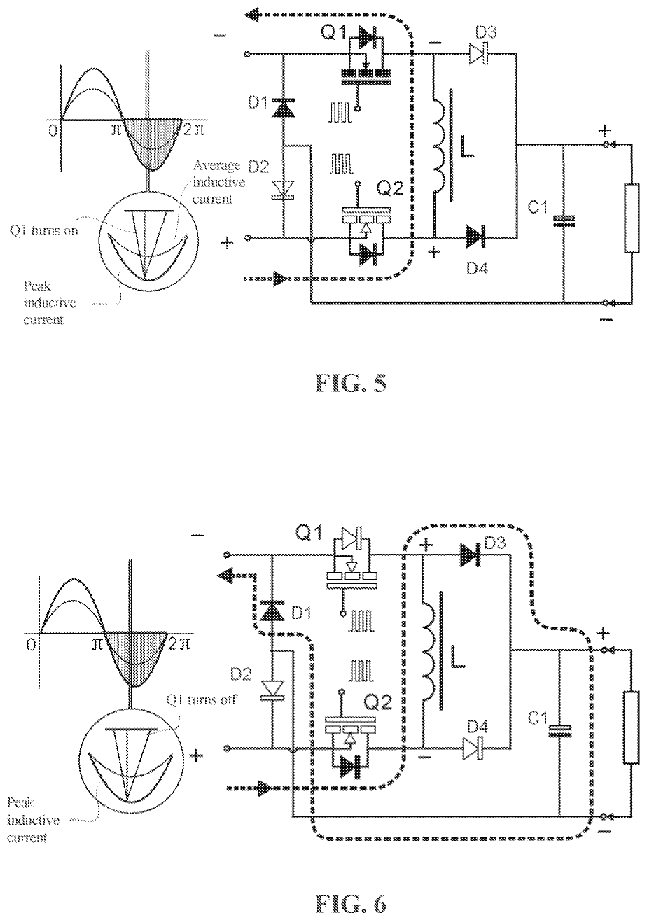

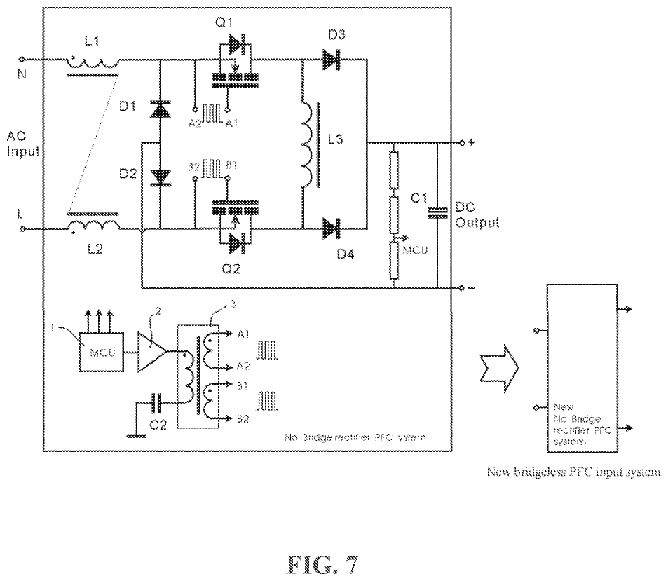

FIG. 6 illustrates the system reverse cycle. Here, Q1 and Q2 are both OFF; and the inductor L enters boost output mode. The output bulk capacitor C1 stores the energy and maintains the voltage to above the peak of input voltage line.

FIG. 7 illustrates the new bridgeless PFC input system. The two active components Q1 and Q2 replace a section of a standard bridge rectifier, and provide additional function to control the boost energy in the system to provide a near perfect Power Factor (e.g., power factor=1).

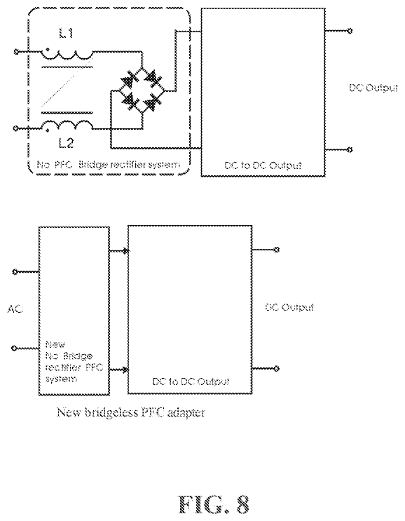

FIG. 8 illustrates the result of eliminating the left bridge rectifier and the common mode choke from the original non-bridgeless PFC adapter and replacing the left bridge rectifier and the common mode choke with the new bridgeless PFC system of the present invention, which is a high-performance AC-DC converter. The standard bridge diodes that are used in the non-bridgeless PFC which are also inefficient are now simple bridgeless active components that provide high Power Factor and high efficiency.

The result of eliminating the left bridge rectifier and common mode choke from the original non-bridgeless PFC adapter and replacing them with the new bridgeless PFC system of the present invention is a high-performance AC-DC converter.

I) Symmetry and Balanced Topology

As illustrated in FIG. 1, using the center of boost inductor L3 as an axis, the main system is composed of one boost inductor L3, two metal-oxide-semiconductor field-effect transistors (MOSFETs) Q1-Q2, and four diodes D1-D4 (two slow diodes and two boost diodes) to form a symmetrical, balanced topology. This topology includes a pair of conventional boost PFC circuits. In other words, with reference to FIG. 1, boost PCF circuits (100) are combined into a single symmetric circuit whose boost components are symmetrical when viewed from an axis passing through the inductor L3. For example, as shown in FIG. 1, a first MOSFET Q1 and diodes D1, D3 form a first switch circuit disposed on a first end of the inductor L3; while a second MOSFET Q2 and diodes D2, D4 form a second switch circuit disposed on a second end of the inductor L3. In this case, the diodes D1, D2 may be connected to a capacitor C1, which may store electric energy (also referred to herein as simply “energy”). In some cases, the inductor L3 may be wired in parallel with the diodes D1 and D2.

Each of the four diodes D1-D4 may be semiconductor and/or other electrical component capable of conducting current primarily in one direction. In other words, each of the four diodes D1-D4 may perform asymmetric conductance: when current is applied in the forward direction, the diode conducts current with little or no resistance, and when current is applied in the reverse direction, the diode provides a high resistance to block or minimize current flow. The diodes D1-D4 may be or comprise slow diodes (e.g., diodes whose design enables slower and/or smoother current decline over time), fast or ultra-fast (e.g., diodes whose design enables the diodes to cease conducting current in the reverse direction more quickly than standard diodes), and/or the like. In some cases, additional diodes may be present in the circuits, devices, and systems discussed herein.

Because the system has symmetrical and balanced topology, a common mode choke can be installed at the input terminal of the power factor correction circuit—a feature not possible with non-bridgeless PFCs—to suppress and filter common mode electromagnetic interference signals, and thus address the common mode (CM) noise problem, i.e., the radiating interference and conducting interference of EMI waves. This performs a wave-filtering role vis-à-vis EMI and suppresses external radiation of high-frequency signal electromagnetic waves, which would be difficult in a bridgeless system with an asymmetric topology.

The symmetrical topology additionally improves the efficiency and simplicity of the circuit, since the symmetric topology is theoretically consistent with the reverse induced electromotive force generated on the inductor L in asymmetric topologies, but without the requirement of a diode bridge to convert alternating current to direct current, improving the power density of the system.

II) A Digital Microcontroller Unit (MCU)

A digital microcontroller unit (MCU) replaces the analog controller. Power factor correction (PFC) is performed by the digital MCU (1) illustrated in FIG. 2. The digital controller has many advantages over a conventional analog controller. It achieves programmable, non-linear control and uses fewer parts to complete complex functions.

III) “Bridgeless”

Bridgeless means there is no bridge rectifier. In other words, AC current is input directly for operation. Traditionally, power factor correction (PFC) circuits employ a bridge rectifier composed of 4 diodes. As is common knowledge, a problem that is common to all bridge PFC topologies is the common-mode (CM) noise problem, i.e., radiated interference and conducted interference of EMI electromagnetic waves. The present invention easily overcomes this problem by removing the bridge rectifier. More specifically, the two active components Q1 and Q2 (e.g., MOSFETs) serve dual functions to perform PFC and rectify the main input line.

Tests and calculations show that a bridge rectifier can only reach an efficiency of PFC at 81% (calculation omitted). Therefore, the present invention eliminates the bridge rectifier, and allows a boost inductor to bear the effects of bidirectional magnetizing current and high-order harmonics. It is thus possible to avoid excessive magnetic saturation and reduce magnetic core volume, thereby increasing system conversion efficiency and system power density. Given the efficiency of 81%, 19% of the energy transmitted by the grid or other AC source is essentially wasted. By introducing a symmetric topology about the inductor, the inductor is able to conduct current in both directions. The self-inductive electromotive force generated by the inductor is in the same direction as the reverse working power supply voltage, improving the efficiency of the inductor. The efficiency of the inductor improves the power density of the circuit.

IV) Circuit Operating Principles

Circuit operating principles are illustrated in FIGS. 3-6.

FIG. 3 illustrates forward cycle: In operation, Q1 and Q2 are both ON and the inductor L enters energy storage mode. At the same time some of the energy starts filling up the bulk capacitor C1. In this case, the energy may also pass into the load (e.g., a DC device) that is connected (e.g., wired, placed, etc.) in parallel with the capacitor C1.

FIG. 4 illustrates forward cycle: In operation, Q1 and Q2 are both OFF; and the inductor L enters boost output mode. The current continuously flowing through the body diode of Q1 and energy stored in the inductor L is carried forward through the boost diode D4 and back to the input line via input diode D2. In this mode the voltage of C1 rises above the peak of the input voltage.

FIG. 5 illustrates reverse cycle: In operation, Q1 and Q2 are both ON and the inductor L enters energy storage mode. At this time the bulk capacitor C1 has the boost energy stored where the voltage is higher than the peak of input line voltage and therefore the boost diode D4 is reversed biased.

FIG. 6 illustrates reverse cycle: In operation, Q1 and Q2 are both OFF; and the inductor L enters boost output mode. The current is continuously flowing from the body diode of Q2 and the stored energy in the inductor L is carried out through the boost diode D3 to the bulk capacitor C1 and returned back to the input line via input diode D1.

V) Effective for Devices in Different Classes

For AC adapters, LED drivers and lamps, industrial and medical power supplies, electric vehicle chargers, and power tool chargers, embodiments of the present invention can, depending on test categories and ranges (low power at 10 W, medium power at 300 W, and high power at 2,000 W; voltage range: 85 VA to 265 VAC), achieve a PFC of to 0.999 and an efficiency of 92% to 98%.

This is due to non-linear adjustments performed by the digital MCU on the system's different voltage segments and power ranges. For example, when the output voltage exceeds the rated voltage of the capacitor C1 and/or the load, the voltage is fed back to the MCU (e.g., via the MOSFETs Q1, Q2). The MCU may then adjust the pulse width of the input voltage, maintain the rated voltage, limit the output power, and/or the like. A diagram of a configuration of an exemplary embodiment of the present invention is shown in FIGS. 7-8. For example, FIG. 8 is the result of eliminating the left bridge rectifier and common mode choke from the original non-PFC adapter and replacing the left bridge rectifier and common mode choke with the new bridgeless PFC system of the present invention, which is a high-performance AC-DC converter.

Thus, it is one aspect of various embodiments of the present invention to provide a bridgeless digital control power factor correction circuit.

One advantage of some embodiments is that due to the symmetry of the circuit, a common mode choke can be installed at the input terminal of the power factor correction circuit to suppress and filter common mode electromagnetic interference signals, and thus address the common mode (CM) noise problem.

Another aspect of embodiments of the present invention is a method for manufacturing a bridgeless digital control power factor correction circuit. More specifically, a method for forming a bridgeless digital control power factor correction circuit is provided, wherein the bridgeless digital power factor correction circuit may be provided in a device to eliminate the use of standby power when a plug is sitting idle in a socket.

Additionally, various features/components of one embodiment may be combined with features/components of another embodiment. For example, features/components of one figure can be combined with features/components of another figure or features/components of multiple figures. To avoid repetition, every different combination of features has not been described herein, but the different combinations are within the scope of this disclosure. Additionally, if details (including angles, dimensions, etc.) about a feature or component are described with one embodiment or one figure, then those details can apply to similar features of components in other embodiments or other figures.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. It is to be understood that the phraseology and terminology used herein is for the purpose of description and should not be regarded as limiting.

It is to be appreciated that any feature described herein can be claimed in combination with any other feature(s) as described herein, regardless of whether the features come from the same described embodiment.

What is claimed is:

1. A bridgeless power factor correction circuit comprising:
a boost inductor, wherein the bridgeless power factor correction circuit has a symmetrical topology, and wherein the boost inductor comprises an axis of the bridgeless power factor correction circuit;
a first metal-oxide-semiconductor field-effect transistor (MOSFET) and a second MOSFET; and
four diodes, wherein the four diodes comprise two slow diodes and two fast diodes.

2. The bridgeless power factor correction circuit of claim 1, further comprising:
a common mode choke, wherein the common mode choke is installed at an input terminal of the bridgeless power factor correction circuit.

3. The bridgeless power factor correction circuit of claim 1, further comprising:
a digital microcontroller unit (MCU).

4. The bridgeless power factor correction circuit of claim 1, wherein the first MOSFET turns ON the second MOSFET, and wherein when the second MOSFET is ON the boost inductor enters an energy storage mode.

5. The bridgeless power factor correction circuit of claim 1, wherein the second MOSFET is OFF, and wherein when the second MOSFET is OFF the boost inductor enters a boost output mode.

6. The bridgeless power factor correction circuit of claim 1, wherein the second MOSFET turns ON the first MOSFET, and wherein when the first MOSFET is ON the boost inductor enters an energy storage mode.

7. The bridgeless power factor correction circuit of claim 1, wherein the first MOSFET is OFF, and wherein when the first MOSFET is OFF the boost inductor enters a boost output mode.

8. A device comprising:
a bridgeless power factor correction circuit comprising:
a boost inductor;
a first metal-oxide-semiconductor field-effect transistor (MOSFET) and a second MOSFET; and
four diodes, wherein the four diodes comprise two slow diodes and two fast diodes; and
a plug.

9. The device of claim 8, wherein the bridgeless power factor correction circuit has a symmetrical topology.

10. The device of claim 9, wherein the boost inductor comprises an axis of the bridgeless power factor correction circuit.

11. A bridgeless power factor correction circuit, comprising:
a first switch circuit that includes a first metal-oxide-semiconductor field-effect transistor (MOSFET) and a first semiconductor;
a second switch circuit that includes a second MOSFET and a second semiconductor; and
an inductor connected to the first switch circuit and to the second switch circuit,
wherein the first switch circuit and the second switch circuit are connectable to an alternating current power source to generate a direct current.

12. The bridgeless power factor correction circuit of claim 11, further comprising:
a capacitor.

13. The bridgeless power factor correction circuit of claim 12, wherein the capacitor is wired in parallel with a load that receives the direct current.

14. The bridgeless power factor correction circuit of claim 11, wherein the first switch circuit further comprises a third semiconductor, and wherein the second switch circuit further comprises a fourth semiconductor.

15. The bridgeless power factor correction circuit of claim 14, wherein a first end of the inductor is connectable to the first switch circuit, and wherein a second end of the inductor opposite the first end is connectable to the second switch circuit.

16. The bridgeless power factor correction circuit of claim 15, wherein the third semiconductor is connected to the fourth semiconductor.

17. The bridgeless power factor correction circuit of claim 16, wherein the third semiconductor and the fourth semiconductor are placed in parallel with the inductor.

18. The bridgeless power factor correction circuit of claim 11, wherein a microcontroller unit turns on the second MOSFET, and wherein, when the second MOSFET is on, the inductor stores electrical energy.

19. The bridgeless power factor correction circuit of claim 11, wherein the second MOSFET is off, and wherein, when the second MOSFET is off, the inductor outputs electrical energy.

20. The bridgeless power factor correction circuit of claim 11, wherein a microcontroller unit turns on the first MOSFET, and wherein, when the first MOSFET is on, the inductor stores electrical energy.
